(19) United States
(12) Patent Application Publication
(10) Pub. No.: US 2014/0047790 A1
(43) Pub. Date: Feb. 20, 2014

(54) Process for manufacturing decorative and facing panels and panel manufactured thereby

(71) Applicant: Emanuele Ferronato, Borso Del Grappa (IT)

(72) Inventor: Emanuele Ferronato, Borso Del Grappa (IT)

(21) Appl. No.: 14/114,462

(22) PCT Filed: Apr. 18, 2012
(86) PCT No.: PCT/IT12/00113

§ 371 Date: Oct. 28, 2013

(30) Foreign Application Priority Data
Apr. 28, 2011 (IT) TV2011A000055

(51) Int. Cl. E04F 13/072; E04F 13/076; B05D 3/12

(52) U.S. Cl. CPC E04F 13/072; B05D 3/12; E04F 13/076
USPC 52/588.1; 427/355; 428/141

(57) ABSTRACT

The present invention concerns a process for manufacturing facing panels in composite material (1) which can be applied to structural and not structural walls, to ceilings, to mobile or fixed surfaces, both inner and external of buildings, enclosures or other structures, mainly, but not exclusively, in home-building field or be used as separate and independent walls too. The invention further concerns the panel (1) built through this process. It allows to make decorative, facing and insulating panels (1) whose thickness changes according to the kind of material (3), which basically reproduce any natural materials, such as stone(s) (14), rock(s), marble, wood and not, for example bricks (15) or other finishes with random shapes at variable height differences (5) in plane or curved surfaces, reducing costs and laying time with great flexibility and easy of use.

### AREA OF APPLICABILITY

The present invention concerns a process for manufacturing facing panels in composite material (1) which can be applied to structural and not structural walls, to ceilings, to mobile or fixed surfaces, both inner and external of buildings, enclosures or other structures, mainly, but not exclusively, in home-building field or be used as separate and independent walls too.

The invention further concerns the panel (1) built through this process. It allows to make decorative, facing and insulating panels (1) whose thickness changes according to the kind of material (3), which basically reproduce any natural materials, such as stone (14), rock, stone, marble, wood and not, for example bricks (15) or other finishes with random shapes at variable height differences (5) in plane or curved surfaces, reducing costs and laying time with great flexibility and easy of use.

### STATE OF THE ART

The use of various prefabricated panels reproducing the outer surface of building structures of stone, rocks, masonry or wood, for covering bearing structures of buildings such walls, columns, arches, frameworks or similar both as a protection and a decoration, is well known.

Examples of implementation of these panels are shown for example in patent documents DE2512460 and U.S. Pat. No. 5,735,094.

In particular it is further known a process for manufacturing panels by using a mixture of cement and inert materials poured into suitable moulds shaped according to the article to reproduce.

When the panel is hardened is extracted from the mould and painted on the visible side.

However these panels show some drawbacks, they are very heavy and it is difficult making them curved or moulded.

Besides such panels do not offer insulation to the wall to protect.

Another embodiment is manufacturing panels in fibreglass: they can be moulded during the production phase at discretion and must necessarily show a high thickness to have a suitable stiffness and mechanical resistance. Even in this case the panel is painted on the surface and it involves color scraping in the long run.

Besides this kind of panels has not insulating characteristics either.

Another embodiment is manufacturing panels made from a mixture of a resin and granules of mineral substances, poured in fluid form into suitable moulds shaped according to the article to reproduce.

When the panel is hardened is extracted from the mould which determines its shape and sizes but this process shows some limits, excludes coupling to other materials during the production phase.

Such panels have a good mechanical stiffness but not insulating properties. Besides the use of various panels with insulating function made of several natural and artificial materials such as cork, wood fibre and other vegetable fibres, polyurethane, polystyrene and other artificial insulating materials is well known but these ones must be protected and faced after exposure with traditional materials such as metals, wood, plasters and others; periodical maintenance and painting are necessary.

Traditional technique of such insulating raw or semi-processed panels application to external or inner of the buildings to isolate through adhesive on the back and screws which pass through them in their thickness, provoking thermal transmittance (thermal leak) which transmit heat, cold and noises is also known.

Another drawback of such technique is that visible protective coating facing, generally plaster, creates an overall surface increasing cracks risk due to building smallest movements or the various materials expansion due to temperature changes.

It is an object of the present invention manufacturing modular protective facing and decorative panels (1), resembling the surface of articles made of natural materials such as stones (14), rock(s), marble, wood, metal or artificial materials with random shapes and patterns for example brick(s) (15) and in the meanwhile insulation compared to presently known solutions.

Another object of the invention is manufacturing insulating facing panels (1) which can be shaped at discretion during the production phase and without sizes limits, with the possibility to change support material kind (3) easily, facilitate the laying and create a protective barrier to atmospheric agents.

Another object of the invention is such panels mechanical application with various embodiments, to avoid thermal transmittance (thermal leak).

The applicant, to solve known technique drawbacks, to reach above-mentioned objects and obtain further advantages, has designed and made the present invention.

### INVENTION DESCRIPTION

The present invention is essentially recited and characterized in independent claims.

Other innovative characteristics of the invention are recited in dependent claims.

According to the invention the facing panel is made of a mixture(s) of cement base and mineral granules at least (2).

Mineral substances granules comprise marble, stone, cement, metal, quartz, wood, chalk, glass granules or artificial substances such as plastic materials in alternative or in combination among them.

The mixture(s) (2) is made of artificial materials such as plastic substances as an alternative or in combination with cement base.

Advantageously such granulate shows granules of variable sizes.

In a preferred embodiment the mixture(s) (2) comprises some natural or artificial fibres.

In an embodiment of the invention the panel shows a mixture(s) shallow layer (2) combined to a different material layer (3).

In a possible manufacturing form the panel shows at least partially arched, corrugated or differently shaped configuration.

According to a variation the panel shows perimetrally some joints with a least a recess or a protrusion (6) to better fit with an adjacent panel shape (FIG. 6).

According to a variation the panel (1) shows one or more lap joints (7) with variable thickness and shapes, to better set an insulating sealing (with complete thermal break).

Advantageously such panel (1), besides being applied to structures such as buildings walls, frameworks or similar, ceilings, enclosures, prefabricated fixed or mobile structures, can be also used as separate and independent wall.

A process for manufacturing a panel (1) according to the invention comprises the following steps at least:

a) shaping of the support panel (3);

b) introduction and arrangement of the support panel (3);

c) mixture's (2) composition preparation;

d) uniform spreading of the mixture(s) (2);

e) uniform spreading of the release agent;

f) moulding and shaping of the mixture(s) (2).

In a preferred manufacturing embodiment the panel shows a reticular additional support made by a reinforcing net (4) embedded in the mixture(s) (2).

In another preferred manufacturing embodiment such reticular part (4) is applied between the mixture(s) (2) and the support panel (3).

In another preferred manufacturing embodiment the reticular additional support made by a reinforcing net-like structure (4) can be embedded in the mixture(s) (2) after its spreading.

In another preferred manufacturing embodiment of the invention can be reproduce the surface of articles made of natural materials such as stones (14), 120 rock(s), marble, wood, metal or artificial materials with random shapes and patterns at variable height differences (5) for example brick(s) (15) in plane or curved surfaces, determined by the molding.

In another preferred manufacturing embodiment of the invention, before mixture(s) (2) hardening, forecasting a plastic deformation of such panel is 125 possible so it can assume a desired configuration, for example angles, arches, undulations and so on or it can be shaped in any other desired shape.

### DRAWINGS ILLUSTRATION

These and other characteristics of the present invention will be disclosed in the following description of a preferred manufacturing form, supplied as an example, not limiting, with reference to attached drawings in which:

The FIGS. 1 and 2 schematically illustrates a front view of a facing panel according to the invention;

FIG. 3 schematically illustrates a partially sectioned front view of a facing panel according to the invention;

FIG. 4 schematically illustrates a cross-section of FIG. 3;

FIG. 5 schematically illustrates a front view of a possible joint between two panels;

FIG. 6 schematically illustrates a cross-section of a possible lap-joint between two panels;

FIG. 7 illustrates process flow chart according to the present invention.

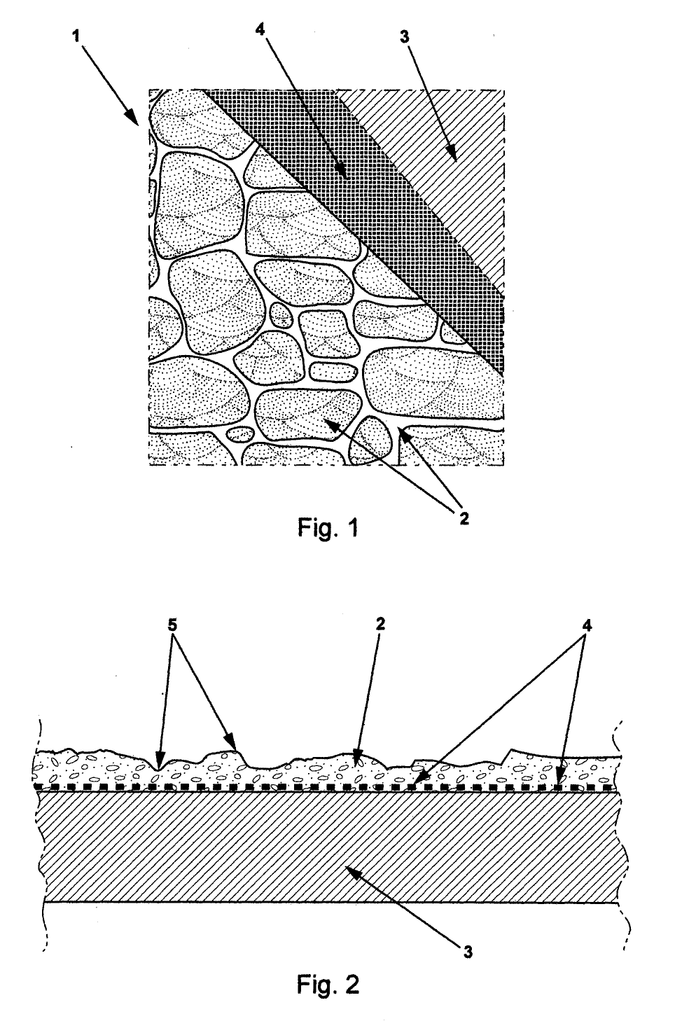

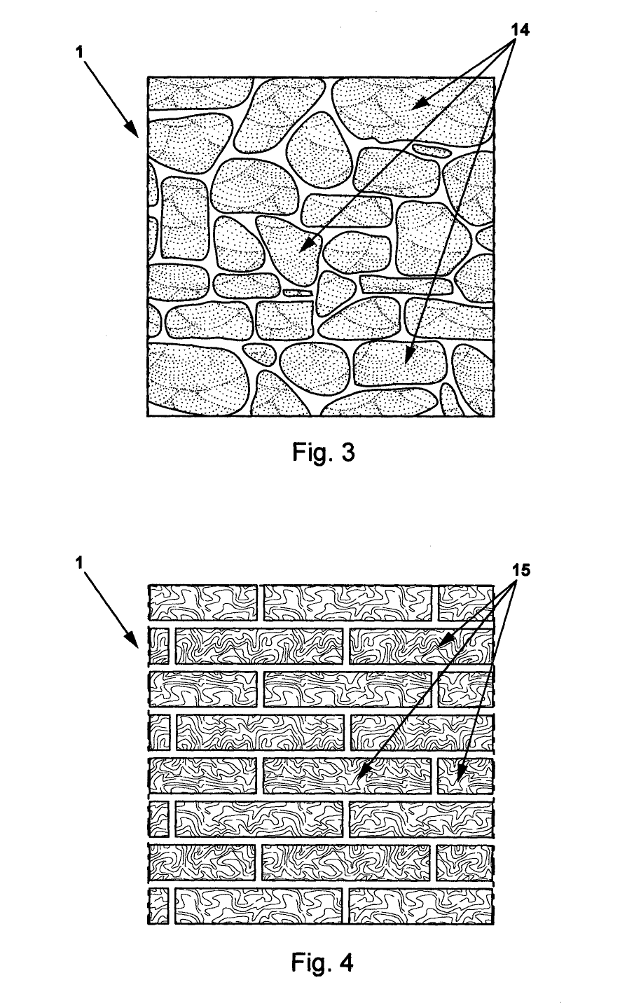

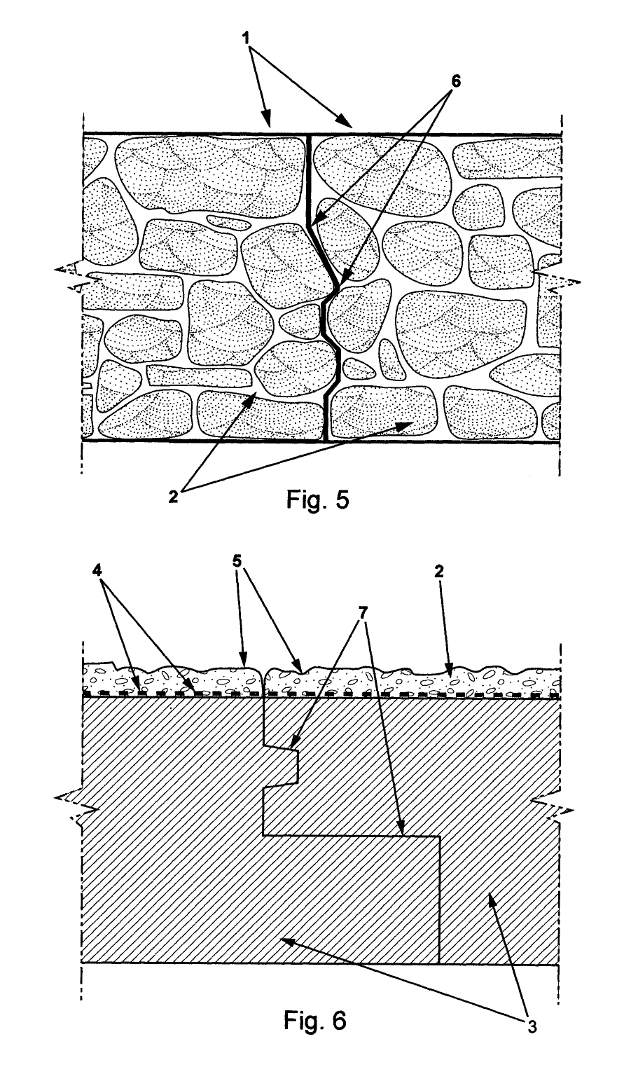

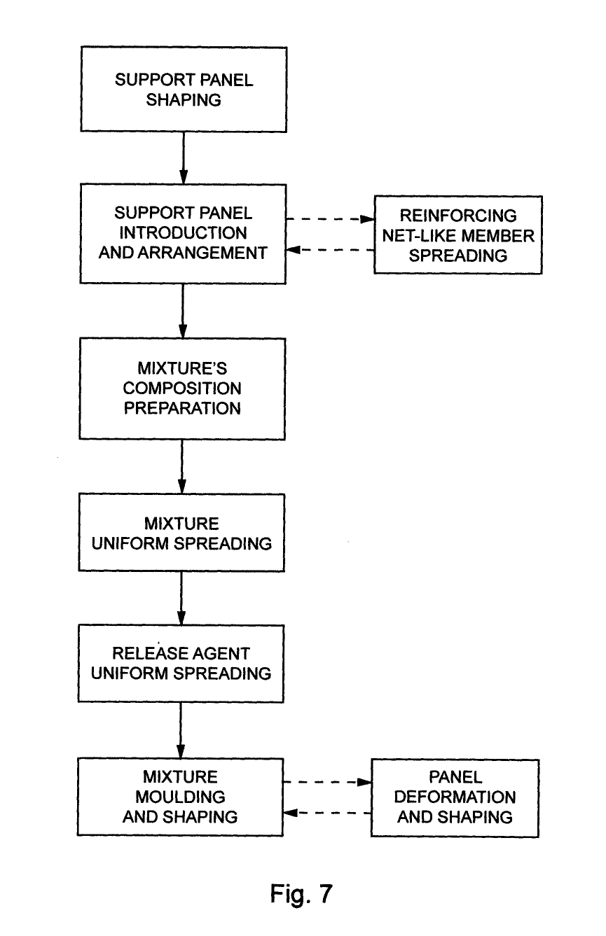

1-8. (canceled)

9. A process for manufacturing a facing panel in composite material resembling a visible surface with random shapes at variable height differences or natural materials such as stone(s), rock(s), marble, wood, brick(s) or other desired material, said process comprising:
a) shaping a support panel;
b) introducing and arranging said support panel;
c) preparing a composition of a mixture;
d) uniformly spreading said mixture(s) on the support panel;
e) uniformly spreading a release agent;
f) moulding and shaping said mixture(s);
wherein before hardening of mixture(s), a possible plastic deformation of said support panel can be provided so that said support panel can assume a desired configuration.

10. The process as claimed in claim 9, wherein the panel comprises a reticular additional support made by a reinforcing net-like structure.

11. The process as claimed in claim 10, wherein the reinforcing net-like structure is spread between step b) and step c).

12. The process as claimed in claim 10, wherein the reinforcing net-like structure is embedded in the mixture(s).

13. The process as claimed in claim 10, wherein the reinforcing net-like structure is embedded in the mixture(s) after spreading d) of the mixture(s).

14. The process as claimed in claim 10, wherein the reinforcing net-like structure is applied between the mixture(s) and the support panel.

15. The process as claimed in claim 9, wherein said support panel is of a material different with respect to the mixture(s).

16. The process as claimed in claim 9, wherein moulding said mixture(s) determines a visible surface finish resembling the surface of articles made of natural materials comprising stone(s), rocks, marble, wood, metals and not brick(s) or other finishes with random patterns and shapes at variable height differences in plane or curved surfaces.

17. Facing panel in composite material and resembling the visible surface with random shapes at variable height differences or natural materials such as stone(s), rock(s), marble, wood, brick(s) or other desired material, said panel comprising a support panel on which at least one layer of mixture(s) is provided.

18. The facing panel as claimed in claim 9, wherein the mixture comprises mineral granule substances and an artificial material comprising at least one of cement, plastic substances, or a combination thereof.

19. The facing panel as claimed in claim 17, wherein said mineral granule substances comprise at least one of marble, stone, cement, metal, quartz, wood, chalk, glass granules, plastic materials, or a combination thereof.

20. The facing panel as claimed in claim 17, wherein said mineral granule substances comprises granules of variable sizes.

21. The facing panel as claimed in claim 17, wherein the mixture comprises natural or artificial fibres.

22. The facing panel as claimed in claim 17, wherein said panel is configured to be applied to structures including buildings walls, frameworks or similar, ceilings, enclosures, prefabricated or mobile structures or can be configured as a separate and independent wall.

23. The facing panel as claimed in claim 17, wherein said panel is perimetrally provided with one or more joints with at least one recess or protrusion configured to fit with an adjacent panel shape.

24. The facing panel as claimed in claim 17, wherein said panel is provided with one or more lap joints.
